(19) United States
(12) Patent Application Publication
(10) Pub. No.: US 2006/0080327 A1
(43) Pub. Date: Apr. 13, 2006

(54) Systems and methods for information management involving taxonomy and lifespan planning

(76) Inventors: Norman W. Gramling, Hoschton, GA (US); Lelyn Tyson, Lawrenceville, GA (US)

Correspondence Address: ALSTON & BIRD LLP;BANK OF AMERICA PLAZA, 101 SOUTH TRYON STREET, SUITE 4000, CHARLOTTE, NC, 28280-4000, US

(21) Appl. No.: 10/961,246

(22) Filed: Oct. 7, 2004

(51) Int. Cl. G06F 7/00

(52) U.S. Cl. 707/100

(57) ABSTRACT

Systems and methods are disclosed for aiding users in collecting, organizing and deploying various types of data that are simultaneously related to at least two taxonomies. In the present invention, the functionalities for facilitating information management include, but not limited to, visualizing the relatedness between the data and the taxonomies, assisting users in strategic planning based in part upon lifespan information of the data, establishing information standards and keeping track of any information change to generate impact analyses and reports. One particular application of the present invention is an Information Technology (IT) Architecture Management System.

### FIELD OF THE INVENTION

The present invention relates generally to systems and methods of information management, and more particularly, relates to systems and methods for aiding users in collecting, organizing and deploying various types of data that are simultaneously related to different taxonomies. The present invention has very broad applicability in the field of information management, and one particular application resides in the field of managing Information Technology (IT) Architecture which is defined to include a set of specifications necessary to effectively manage any change within the IT environment.

### BACKGROUND OF THE INVENTION

The Information Technology (IT) architectures used by businesses are becoming increasingly complex. Made up of literally all resources for IT services delivery in an enterprise including, but not limited to, technology, organization and various enterprise management systems, such IT architectures may involve thousands of individual hardware and software components (e.g., mainframe computers, servers, printers, workstations, various wide and local area networks, operating systems, middleware, applications, and databases) and organizational elements (e.g., departments, sub-units, sub-groups, personnel). Normally a large number and variety of information relating to the IT architecture exists in an enterprise. During the process of building and managing the IT Architecture, massive amounts of data associated with the IT architecture will be continuously generated. For example, any upgrade of pre-existing technology generates data for new technological elements. Information on organizational elements can also change as a lot of enterprises are in a constant state of reorganization and restructuring.

Ideally, the above-identified various information or data would be well-organized and maintained on a regular basis so as to be readily available to decision makers of an enterprise, such as a CIO (Chief Information Officer), in order to accomplish centralized IT architecture planning and management. In particular, decision makers would be interested in knowing what IT components each organizational unit within an enterprise is currently using or plans to use, what future IT standards to adopt for the entire enterprise, how to retire dated IT assets and procure new IT assets in a strategic manner in order to minimize the impact of architecture changes on the enterprise, how to control and lower the Total Cost of Ownership (TCO) associated with IT architecture, and how to build a consistent IT architecture in consideration of various aspects of the enterprise such as finance, human resources, administration, daily operation, etc.

At present, in most enterprises such data relating to IT architecture is decentralized. In other words, the information/data spreads out across the enterprise and is deployed by different organizational elements, such as sales, accounting, and engineering departments. From the perspective of each individual organization, the decentralized information environment tends to be more responsive and flexible. For enterprise decision makers, however, recognition of non-standard and unsupported information technology elements used by different organizational units is seriously inhibited. As a result, decision makers will find it difficult to effectively manage the enterprise IT architecture. For instance, different organizations within one enterprise often adopt different IT standards based on their own specific needs or preferences. Lack of enterprise-wise standards may cause inappropriate acquisition of IT assets that would increase overall support and overhead requirements and inhibit interoperability between existing IT assets in the enterprise architecture. Further, lack of sufficient visibility may result in non-use or waste of certain IT assets already existing in the enterprise. Therefore, decision makers have a need for visibility of various information or data relating to the IT architecture.

Meanwhile, data relating to IT architecture normally has tremendous amount and easily becomes dated or degraded. Any prolonged maintenance or storage of such data is almost inhibited because all existing data storage mechanisms and media are limited, while such data can increase exponentially. Further, maintenance of this data requires intensive labor and time, especially when the data is not well organized, and the high maintenance cost is not justifiable given the rapidly diminishing value of such data. Therefore, there is also a need to reduce data maintenance cost and provide real-time presentation and deployment of this data in order to derive the maximum data value.

As a matter of fact, the above-stated problems associated with IT architecture management may exist in numerous contexts in reality. For example, a pharmaceutical company needs to collect, organize and employ tremendous amount of data related to its medical products, each being developed from different formulas and comprising a variety of ingredients. Over time production of certain existing products may be abandoned with the advent of new medical products resulting from constant R&D activities. As all these different contexts are examined closely, it appears that, typically, data involved in these contexts can be identified and organized as associated with different taxonomies. Take the IT architecture for example. Specifications relating to each IT architectural element can be identified and documented once an organization entity from within the organizational taxonomy and an IT architecture domain from within the IT architecture taxonomy are determined. E.g., data relating to Windows 2000, Windows XP, etc, may be identified when we associate an organization element—Accounting Department—with an IT architectural element—Operating Systems—by making an inquiry “what operating systems does an accounting department of an enterprise use?” In addition, most of the data has limited lifespan for use because they are constantly updated throughout a lifecycle. In the IT architecture example, the accounting department may upgrade their operating systems from Windows 98 to Windows 2000 within a certain period of time. That means, data related to both the accounting department and the operating systems will be changed from time to time.

In light of the above, it is one object of the present invention to provide a method and system for managing all kinds of data that can be related to different taxonomies. Such data typically has limited usage lifespan. It is a further object of the present invention to provide an organized visual environment for managing information relating to different taxonomies under such method and system.

It is another object of the present invention to enable a user to have strategic planning and management of the above-mentioned data related to different taxonomies based upon visualized lifespan information. Through the present invention, the various stages of the information can be controlled, tracked and reported in both a reactive and proactive manner. Especially for IT Management purposes, the present invention would facilitate retirement of old IT assets and acquisition of new IT assets in view of the lifespan information of each individual sub-entity within the entire enterprise.

In addition, it is yet another object of the present invention to provide standard guidance for generating new data and thus facilitate standardization of information for various tiers of taxonomies. Specific to the IT management context, an organization-wise IT standard can be provided whenever one entity of the organization entity decides to upgrade or downgrade their IT architectural elements.

### BRIEF SUMMARY OF THE INVENTION

In carrying out the above objects and other objects, features and advantages, the present invention provides a method for information management involving taxonomies and lifespan planning. Specifically, one embodiment of the present invention provides a system and method of information management involving taxonomy and lifespan planning. In the claimed system and method, a user is allowed to select a first taxonomy domain from a first hierarchical classification system that presents a first set of taxonomy domains in various tiers of a first taxonomy, and further, a second taxonomy domain from a second hierarchical classification system that presents a second set of taxonomy domains in various tiers of a second taxonomy. After receiving the first taxonomy domain and second taxonomy domain from said user, an association is generated between said first taxonomy domain and said second taxonomy domain. An association is related to one or more instances, and each instance is defined by an element and a specification. Such instances are identified through the steps of: (1) generating an environment status for the association and the environment status comprises one or more statuses; (2) generating a lifespan stage for the association and the lifespan stage comprises one or more stages that correspond to the one or more statuses of the environment status; (3) for each of the one or more statuses of said environmental status, determining whether an instance related to that association exists in the status; and (4) further identifying a stage term and a date of entry for the instance in the stage.

In one preferred embodiment, the first taxonomy is an organization comprising one selected from the group of an enterprise, a corporation, a non-profit association, a government department or any other entities, while the second taxonomy is an Information Technology (IT) architecture. Thus, this preferred embodiment provides a specific system and method for IT architecture information management.

In another preferred embodiment, the claimed system and method further allows a user to select a particular instance for modification and the modifiable information includes the environment status, lifespan stage, stage term, date of entry, specification, and element related to the particular instance.

Another embodiment of the present invention provides a method and system for managing information associated with different taxonomies, which includes the steps of: allowing a user to select a first taxonomy domain from a first taxonomy, and further select a second taxonomy domain from a second taxonomy; responsive to receiving the first taxonomy domain and second taxonomy domain, determining whether neither domain has sub-domains, and if so, searching a database storing data regarding a plurality of instances to identify one or more instances relating to an association between said first taxonomy domain and said second taxonomy domain and display the one or more instances in an environment status and a lifespan stage; and otherwise, triggering a rollup application prior to displaying any instances relating to the association between the two domains. In particular, the rollup application comprises the steps of: identifying a set of sub-domains of the first taxonomy domain; associating each of the set of sub-domains with the second taxonomy domain to create a set of sub-associations; for each of the set of sub-associations, searching the database to identify instances relating to the sub-association; categorizing said instances into several groups of instances based upon a specific item, each of the groups of instances having the same value of said specific item; and incrementing counts for each of the several groups of instances.

According to an alternative embodiment of the present invention, a system and method are provided for standardization in managing information on various levels. The claimed system and method include the steps of: allowing a user to select a first taxonomy domain from a first information taxonomy and a second taxonomy domain from a second information taxonomy; identifying and displaying one or more instances from a database storing data for a number of instances, said one or more instances relating to an association between said first taxonomy domain and said second taxonomy domain; allowing said user to insert an additional instance as related to said association; determining whether said additional instance is marked by said user as standard, and if not, inserting said additional instance into said database as related to said association; (A) responsive to the determination that said additional instance is marked as standard, further determining whether said first taxonomy domain is a first standard domain of said first information taxonomy, and if so, marking said additional instance as a first standard for said second taxonomy domain prior to inserting said additional instance into said database as related to said association; and (B) responsive to the determination that said first taxonomy domain is not said first standard domain of said first information taxonomy, determining whether said first standard exists for said second taxonomy domain, (1) responsive to the determination that said first standard does not exist for said second taxonomy domain, marking said additional instance as a second standard for said second taxonomy domain prior to inserting said additional instance into said database as related to said association, and (2) responsive to the determination that said first standard exists for said second taxonomy domain, determining whether said additional instance matches said first standard, (a) responsive to the determination that said additional instance matches said first standard, marking said additional instance as a third standard matching said first standard for said second taxonomy domain prior to inserting said additional instance into said database as related to said association, and (b) responsive to the determination that said additional instance does not match said first standard, alerting to said user that said additional instance does not match said first standard.

Yet another embodiment of the present invention provides a method of impact analysis for information management, which comprises the steps of: identifying a first instance related to a first association between a first organizational taxonomy domain with a first architectural taxonomy domain; displaying information regarding said first instance for a user input to modify said information, said information including an element, a specification, an environment status, a lifespan stage and related stage terms and dates of entry in connection with said first instance; modifying said first instance based upon said user input; identifying a second instance related to a second association between a second organizational taxonomy domain with a second architectural taxonomy domain; determining a change in said second instance as a result of modifying said first instance; and generating a report including said modification of said first instance and said change in said second instance.

One additional embodiment of the present invention provides a method for facilitating cost control in IT asset management, said method comprising the steps of: selecting an organization taxonomy domain from a hierarchical organization taxonomy comprising multiple organization taxonomy domains; selecting an architecture taxonomy domain from a hierarchical architecture taxonomy comprising multiple architecture taxonomy domains; searching a database based upon an association between said organization taxonomy domain and said architecture taxonomy domain to identify one or more instances related to said association, each of said one or more instances comprising a specific item of cost; and calculating, for said organization taxonomy domain associated with said architecture taxonomy domain, a total cost of said one or more instances based upon said specific item of cost.

### BRIEF DESCRIPTION OF THE SEVERAL VIEWS OF THE DRAWING(S)

FIGS. 1a-b show exemplary illustrations of the hierarchical structure of an information taxonomy;

FIGS. 2a-b show an information management lifespan model that visualizes the relationship of a status and a stage of the information;

FIG. 3 shows a database containing various related information elements involved in an Information Technology Architecture Management System (ITIMS) according to one embodiment of the present invention;

FIG. 4 is a high-level block diagram of the system in FIG. 3 according to one embodiment of the present invention;

FIG. 5 is an exemplary screen display of the system in FIG. 3 according to one embodiment of the present invention;

FIG. 6 is an illustrative flow diagram of the information management function performed by the system in FIG. 3 according to the embodiment of the present invention;

FIG. 7 is an exemplary screen display of the system in FIG. 3 that illustrates the information management function of FIG. 6 according to one embodiment of the present invention;

FIG. 8 is a flow diagram of the instance-rollup functionality performed by the system in FIG. 3 according to one embodiment of the present invention;

FIG. 9 is an exemplary screen display of the system in FIG. 3 that illustrates the instance-rollup functionality in FIG. 8 according to one embodiment of the present invention;

FIG. 10 is an exemplary screen display of the system in FIG. 3 that illustrates the details of an instance according to one embodiment of the present invention;

FIG. 11 is an exemplary screen display of the system in FIG. 3 that illustrates the element-editing function according to one embodiment of the present invention;

FIG. 12 is an exemplary screen display of the system in FIG. 3 that illustrates the standard-setting function according to one embodiment of the present invention;

FIG. 13 is a flow diagram of the standards-setting functionality performed by the system in FIG. 3 according to one embodiment of the present invention;

FIGS. 14a-b show the computer hardware architecture that implements the system in FIG. 3 according to one embodiment of the present invention.

### DETAILED DESCRIPTION OF THE INVENTION

The present inventions now will be described more fully hereinafter with reference to the accompanying drawings, in which some, but not all embodiments of the invention are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

An Overview of the Present Invention

Information Taxonomies and Their Relatedness

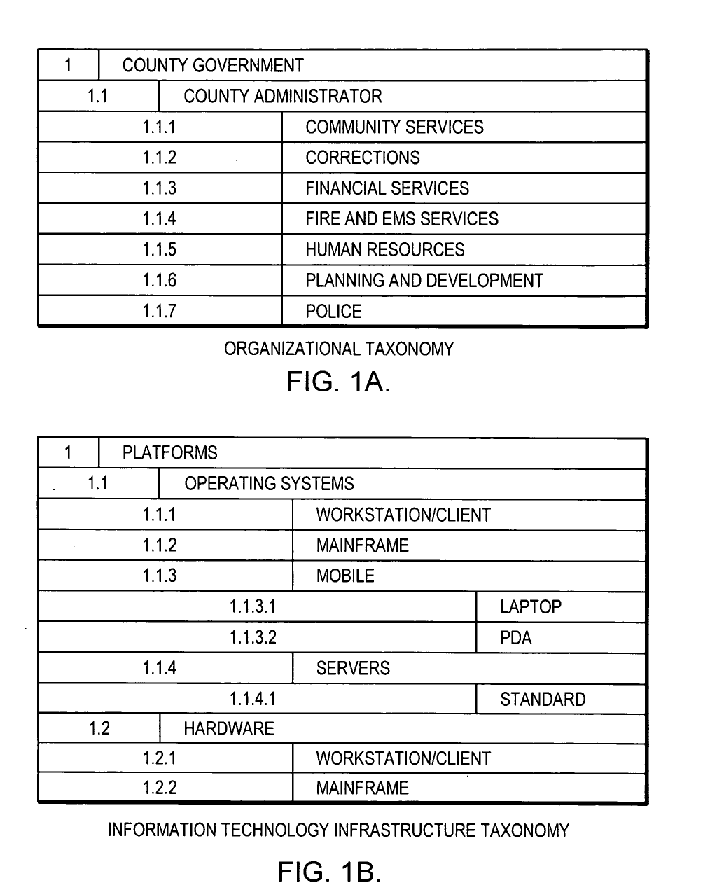

In the present invention, the subject matter to be managed is data that can be identified when two information taxonomies are determined and associated. Such data may already exist independently, or is newly created in a bi-dimensional information environment as a result of associating two different taxonomies. For example, FIGS. 1a-b show an organization taxonomy and an Information Technology (IT) architecture taxonomy.

As seen in FIG. 1a, such an organization or enterprise taxonomy is comprised of multiple domains identified by ‘1’, ‘1.1’, ‘1.1.1’, ‘1.1.2’, etc. Each domain represents an organizational element within the organization, e.g., Domain ‘1’ corresponds to a “County Government”, Domain ‘1.1’ corresponds to a “County Administrator”, Domain ‘1.1.1’ corresponds to “Community Services”, and so forth. All of the domains are organized in a hierarchy as mapping various levels or tiers of any organization in the real world. For instance, “Community Services” is one level lower than a “County Administrator” in the “County Government” organization. Accordingly, Domain ‘1.1.1’ is subsidiary to Domain ‘1.1’, and in turn, Domain ‘1.1’ is a superior domain to Domain ‘1.1.1’. Based upon their respective hierarchical positions, there are three types of domains in a taxonomy: (a). a leaf domain that has no subsidiary domain (e.g., Domain ‘1.1.1’ “Community Services”, Domain ‘1.1.2’ “Corrections”, etc.), (b). a root domain that has no superior domains (e.g., Domain ‘1’ “County Government”), (c). a branch domain that has both subsidiary domains and superior domains (e.g., Domain ‘1.1’ “County Administrator”).

In FIG. 1b, an IT architecture taxonomy is presented as comprising multiple domains that map all of the IT elements existing in various ties of an IT architecture. Similar to the above organization taxonomy, this IT architecture taxonomy also contains three types of domains: root domains (e.g., Domain ‘1’ representing “Platforms”), branch domains (e.g., Domain ‘1.1’ representing “Operating Systems”, Domain ‘1.1.1’ representing “Workstation/Client”), and leaf domains (e.g., Domain ‘1.1.3.1’ representing “Laptop”, Domain ‘1.1.4.1’ representing “Standard”).

The above two taxonomies can be associated to the extent that each organizational division or subdivision as identified by a domain of the organization taxonomy may own one or more IT assets, and each IT asset can be categorized in a certain level of an IT architecture mapped by the IT architecture taxonomy. By associating respective organizational domains with respective IT architecture domains, all information relating to the IT assets (e.g., serial number, manufacturer, acquisition cost, and acquisition date) will be easily collected, organized and identified by referring to both taxonomies.

Information Lifespan Model

Speaking of the data to be managed in the present invention, a common feature is limited usage lifespan of such data. A typical case is IT assets, hardware and software, which will be retired with the advent of advanced technology or new user demands. As a result, any data relating to a particular piece of IT asset can be changing constantly, as the status of this particular piece changes from new introduction to retirement. When a piece of IT asset is acquired, its related data may be set as the emerging IT standards for the overall enterprise/organization. But when the piece of asset is retired, its related data may be discarded or marked as historical records.

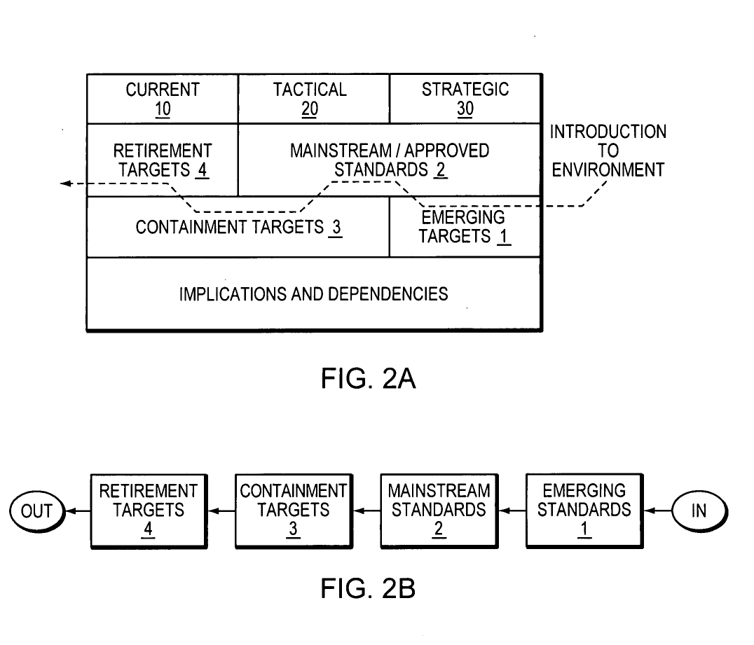

FIGS. 2a-b illustrates an information lifespan model that explains the above-mentioned example. In this model, FIG. 2b demonstrates that any IT asset will come into use, go through four stages during a lifespan of usage, namely, Research & Development (R&D) 1, Approved Targets 2, Containment Targets 3 and Retirement Targets 4, and become out of use afterwards. As can be easily appreciated, the above-identified names for the four stages are not limited to what is recited herein, but can be varied by users. For example, a user may name the second stage as “Mainstream” instead of “Approved Targets”.

Each lifespan stage is related to the environment status of a certain IT asset specification, namely, a then-existing status which can be any one or one combination of Current 10, Tactical 20 or Strategic 30. Similarly, the names of “current”, “tactical” and “strategic” are only exemplary status. A user may easily rename each status based on the user's preferences. The dependencies between a lifespan stage and an environmental status are exemplified in FIG. 2a. By default, they include: (1) if an IT instance is solely in the status of Current 10, the corresponding lifespan stage of this IT instance will default to be Retirement Targets 4, meaning that the instance is in current use but may be retired shortly; (2) if an IT instance is in both the status of Current 10 and the status of Tactical 20, the corresponding lifespan stage of the IT instance will be Containment Targets 3, meaning that the IT instance is currently used and will remain in use in a short term; (3) If an IT instance is in both the status of Tactical 20 and the status of Strategic 30, the corresponding lifespan stage of the IT instance will be Approved Targets 2, meaning that use of the asset will be in a short-term plan as well as a long-term one; (4) If an IT instance is placed solely in the status of Strategic 30, the corresponding lifespan stage of the IT instance will default to R&D 1, meaning that the introduction of that IT instance is in a long-term plan. By referring to a combination of an environment status and a lifespan stage, a user can view the potential movement, as well as then-existing status, of any IT asset specification during its lifespan within that environment.

ITIMS: A Particular Application According to the Present Invention

For illustration purposes, the following discussion of the present invention is based upon a specific example, namely, an Information Technology (IT) Architecture Management System (“the system”). As aforementioned, it should be appreciated that the current invention is not limited to the IT architecture context, but may have very broad applicability in almost any context involving strategic planning and management of information/data that have life cycles.

System Hardware Architecture

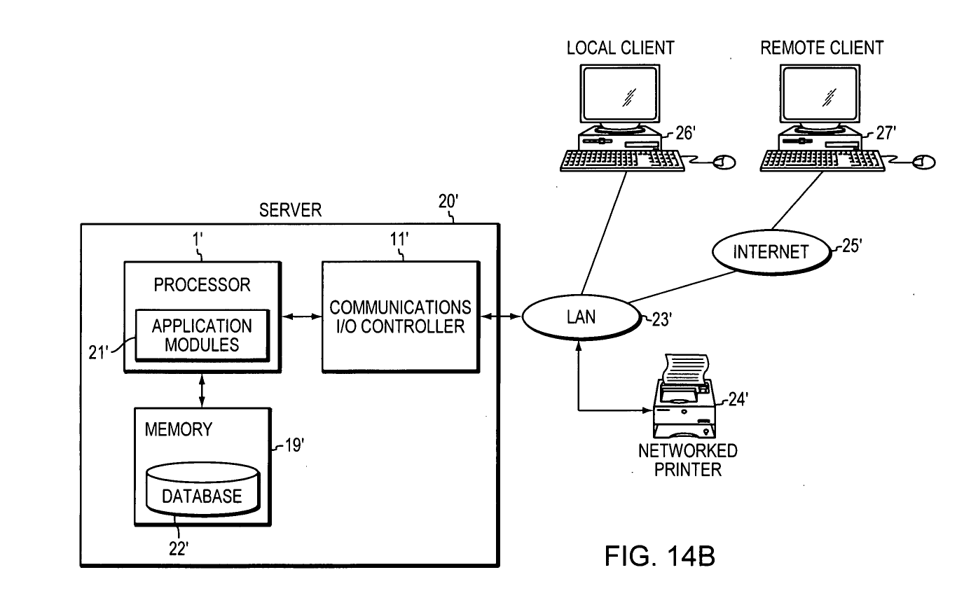

Turning to FIG. 14a, one embodiment of a computer is illustrated that can be used to practice aspects of the present invention. In FIG. 14a, a processor 1′, such as a microprocessor, is used to execute software instructions (i.e., application modules 21′ as shown in FIG. 14a) for carrying out the defined steps of the present invention. The processor 1′ receives power from a power supply 17′ that also provides power to the other components as necessary. The processor 1′ communicates using a data bus 5′ that is typically 16 or 32 bits wide (e.g., in parallel). The data bus 5′ is used to convey data and program instructions, typically, between the processor 1′ and a memory 19′. In the present embodiment, the memory 19′ is comprised of a primary memory 2′ that is RAM or other forms which retain the contents only during operation, or non-volatile 3′, such as ROM, EPROM, EEPROM, FLASH, or other types of memory that retain the memory contents at all times. As seen in FIG. 14b, a database 22′ resides in the primary memory 2′ or 3′ of the memory 19′. The memory 19′ could also be secondary memory 4′, such as disk storage, that stores large amount of data. In some embodiments, the disk storage may communicate with the processor 19′ using an I/O bus 6′ instead or a dedicated bus (not shown). The secondary memory 4′ may be a floppy disk, hard disk, compact disk, DVD, or any other type of mass storage type known to those skilled in the computer arts.

The processor 1′ also communicates with various peripherals or external devices using an I/O bus 6′. In the present embodiment, a peripheral I/O controller 7′ is used to provide standard interfaces, such as RS-232, RS422, DIN, USB, or other interfaces as appropriate to interface various input/output devices. Typical input/output devices include local printers 18′, a monitor 8′, a keyboard 9′, and a mouse 10′ or other typical pointing devices (e.g., rollerball, trackpad, joystick, etc.).

The processor 1′ typically also communicates using a communications I/O controller 11′ with external communication networks, and may use a variety of interfaces such as data communication oriented protocols 12′ such as X.25, ISDN, DSL, cable modems, etc. The communications controller 11′ may also incorporate a modem (not shown) for interfacing and communicating with a standard telephone line 13′. Finally, the communications I/O controller may incorporate an Ethernet interface 14′ for communicating over a LAN. Any of these interfaces may be used to access the Internet, intranets, LANs, or other data communication facilities.

Finally, the processor 1′ may communicate with a wireless interface 16′ that is operatively connected to an antenna 15′ for communicating wirelessly with another devices, using for example, one of the IEEE 802.11 protocols, 802.15.4 protocol, or a standard 3G wireless telecommunications protocols, such as CDMA2000 1x EV-DO, GPRS, W-CDMA, or other protocol.

FIG. 14b illustrates a distributed communication and processing architecture in one embodiment of the present system architecture. A server 11′ is a computer having the above-described embodiment. The server 11′ can communicate with either a local client computer 26′ or a remote client computer 27′. The server 11′ comprises the processor 1′ that is configured to execute program instructions, such as the application modules 21′. The processor 1′ has access to the database 22′ in the memory 19′. In accordance with one preferred embodiment of the present invention, the database 22′ is a relational database. The processor 1′ communicates with external devices using the Communication I/O controller 11′ that typically interfaces with a LAN 23′. The LAN 23′ may provide local connectivity to a networked printer 24′ and the local client computer 26′. Communication with remote devices typically is accomplished by routing data from the LAN 23′ over a communications facility to the Internet 25′. A remote client computer 27′ may execute a web browser, so that the remote client 27′ may interact with the server 20′ as required by transmitted data through the Internet 25′, over the LAN 23′, and to the server 20′.

System Components

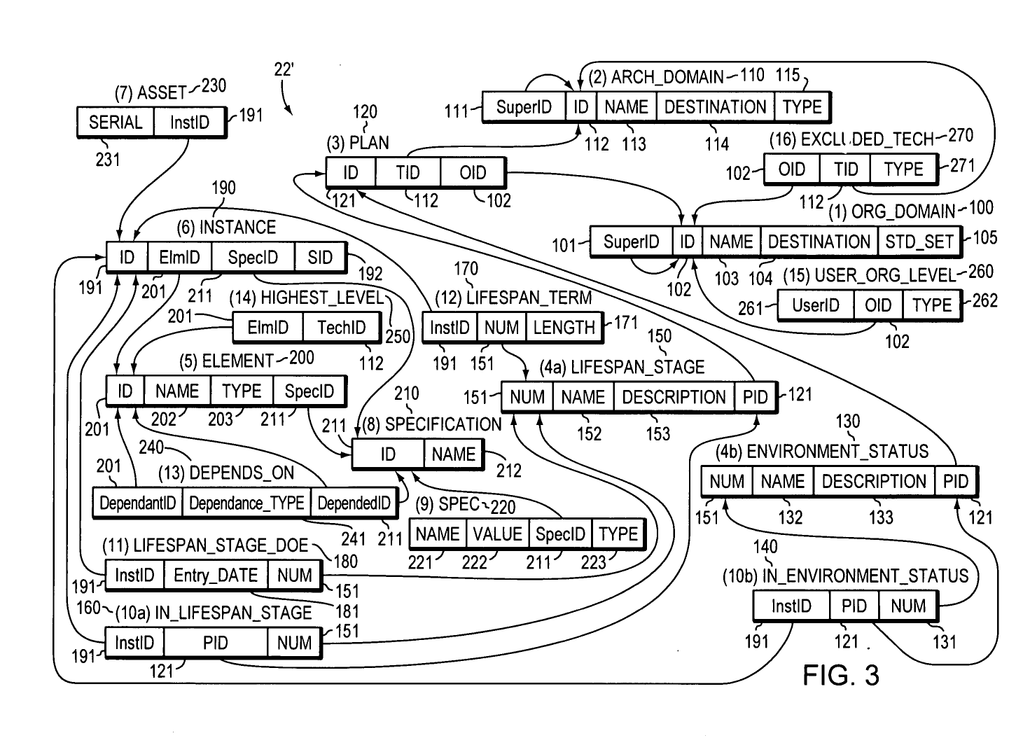

A primary component of the system is a relational database 22′ including a number of data tables that are connected to one another, directly or indirectly, by means of one or more key fields. FIG. 3 provides an overview of this relational database 22′ containing these data tables. Each individual data table will be described in detail in the following paragraphs.

1. Organization Taxonomy (ORG_DOMAIN 100)

As seen below, this table contains five fields: SuperID 101, ID 102, Name 103, Description 104 and STD_SET 105. ID 102 is a data string identifying an organizational domain. SuperID 101 is a data string referencing a super domain of the identified organization domain. As explained above, ID 102 is in the form of ‘X.Y’, in which X is the same as the corresponding SuperID 101. For example, the third domain beneath a super domain ‘3.2.1’ is a domain ‘3.2.1.3’. Name 103 is an assigned name or title for the identified organizational domain. Description 104 provides further description of the domain and it is an optional field. STD_SET 105 is a flag determining the standards setting operations allowed at the identified domain. It is assigned with different values to reflect whether the identified domain is an Enterprise Standards Domain, a standards setting domain, or a non-standards setting domain. The concept of standards setting will be described in detail hereinafter. To explain briefly here, all instance entries into associations of the Enterprise Standards Domain at a given ARCH domain are marked as the Enterprise standard for the given ARCH domain. An instance entered at a standards setting ORG domain, and a given ARCH domain, for which no ENT standard has been defined, is also placed in the corresponding association between the Enterprise Standards Domain and the current ARCH domain, and is therefore marked as the ENT standard for the given ARCH domain. An instance entered at a standards setting ORG domain, which does not match the corresponding Enterprise standard for the given ARCH domain, is marked as an association/plan standard. A non-standards setting domain can be marked as a standard matching the ENT standard, or as the association/plan standard, but never as the Enterprise standard.

ORG_DOMAIN

| SuperID | ID | Name | Description | STD_SET |
|---|---|---|---|---|
| ‘3’ | ‘3.1’ | ‘County | | 0 |
| | | Administrator’ | | |
| ‘3.1’ | ‘3.1.1’ | ‘Police’ | | −1 |
| ‘3.1’ | ‘3.1.2’ | ‘Financial | ‘Corporate Fianncial | −1 |
| | | Service’ | Office - Dallas’ | |
| . . . | . . . | . . . | . . . | . . . |

2. IT Architecture Taxonomy (ARCH_DOMAIN 110)

As seen below, every data record in this table represents an IT architectural domain, comprising a field of SuperID 111, a field of ID 112, a field of Name 113, a field of Description 114, and a field of Type 115. These fields are used to identify an IT architectural domain in a way similar to the above-explained fields in the Organization Taxonomy, except that Type 115 is a flag identifying a specific type of the IT architecture domain, which is not limited to Software and Hardware, but can also be Services, Procedures, Skills, etc.

ARCH_DOMAIN

| SuperID | ID | Name | Description | Type |
|---|---|---|---|---|
| ‘−1’ | ‘1’ | ‘Software’ | ‘Web browsers used | ‘Software’ |
| | | | to access Internet & | |
| | | | Intranet’ | |
| ‘1’ | ‘1.1’ | ‘Desktop | ‘All software running | ‘Software’ |
| | | Software’ | on Mac & PC | |
| | | | Desktops’ | |
| ‘1’ | ‘1.2’ | ‘Mainframe | ‘Machine/Unix | ‘Software’ |
| | | Software’ | Software’ | |
| ‘1.1’ | ‘1.1.1’ | ‘Web Browsers’ | ‘Web browsers used | ‘Software’ |
| | | | to access Internet & | |
| | | | Intranet’ | |
| ‘1.1’ | ‘1.1.2’ | ‘Operating | ‘Desktop (Mac & | ‘Software’ |
| | | System’ | PC) Operating | |
| | | | Systems’ | |
| . . . | . . . | . . . | . . . | . . . |

3. Association (PLAN 120)

Below is table of PLAN 120 that links the organization taxonomy 100 and IT architecture taxonomy 110. Each data record in this table is, as identified by ID 121, an association between a particular organization domain of the organization taxonomy 100, referred by OID 102, and an IT architectural domain of IT architecture taxonomy 110, referred by TID 112. As will be discussed later, an association is related to one or more instances, each of which exists in one status of an environment status, and further, in one stage of a lifespan stage.

PLAN

| ID | TID | OID |
|---|---|---|
| 1002 | ‘1.1.2’ | ‘3.1.2’ |
| 1003 | ‘2.2.1’ | ‘1’ |
| 1008 | ‘3.1.2’ | ‘3.1.2’ |
| . . . | . . . | . . . |

4. Environment Status (ENVIRONMENT_STATUS 130)

Below is a table of ENVIRONMENT_STATUS 130 that links an association and an environment status. An environment configuration may contain many individual status fields. Each individual status field is identified by a field of StatusNum 131 and further described by the fields of Name 132 and Description 133. For example, a particular status ‘1’ is named “current” and described as ‘existing today’. The field of PID 121 links this table to the Table PLAN 120. As seen below, the association identified by PID ‘1002’ is related to instances (not shown in this figure) that respectively exist in three statuses: Status 1—“current”, Status 2—“tactical”, and Status 3—“strategic”.

ENVIRONMENT STATUS

| StatusNum | Name | Description | PID |
|---|---|---|---|
| 1 | ‘Current’ | ‘existing today’ | 1002 |
| 2 | ‘Tactical’ | ‘the short term or | 1002 |
| | | budget impact’ | |
| 3 | ‘Strategic’ | ‘planned use’ | 1002 |
| . . . | . . . | . . . | . . . |

5. Respective Statuses in Environment Status (IN_ENVIRONMENT STATUS 140)

The below table of IN_ENVIRONMENT STATUS 140 further links an association to instances that exist in one or more individual statuses of an environment status. In each data record, an instance is referred by an InstID 191 defined in a table of INSTANCE 190, an association is referred by the PED 121, and an individual status in which the instance exists is referred by the StatusNum 131. For example, the association ‘1002’ is related to an instance ‘879’ that exists in status ‘2’ that is a ‘tactical’ status as referencing the table of ENVIRONMENT_STATUS 130.

IN_ENVIRONMENT STATUS

| InsID | PID | StatusNum |
|---|---|---|
| 879 | 1002 | 2 |
| 879 | 1002 | 3 |
| . . . | . . . | . . . |

6. Lifespan Stage (LIFESPAN_STAGE 150)

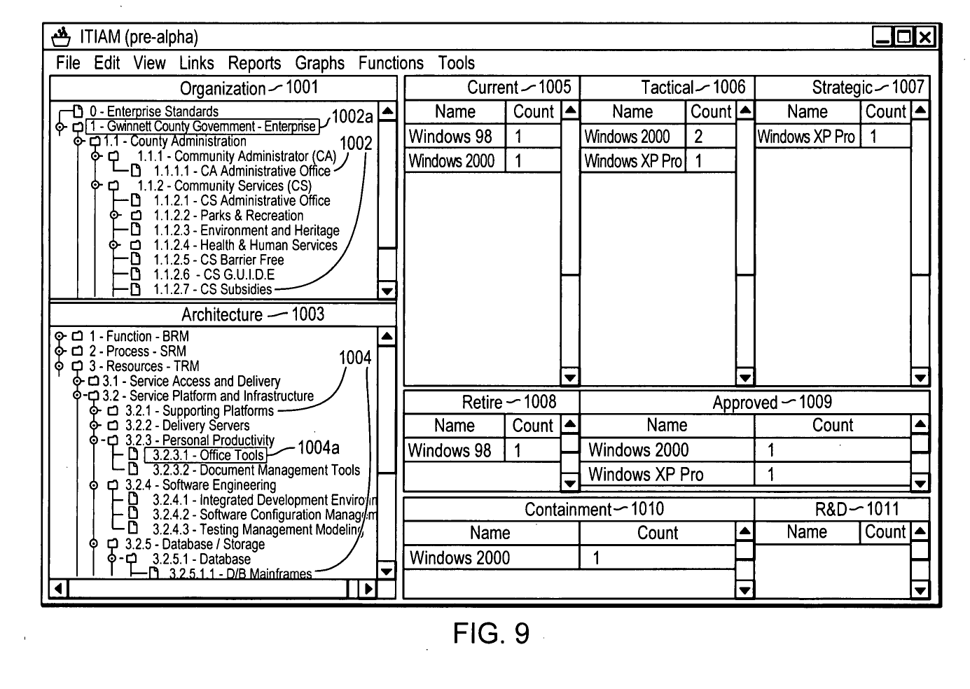

A table of LIFESPAN_STAGE 150 links an association and a lifespan stage. A lifespan stage contains more than one individual stage. Each individual stage is identified by a field of StageNum 151 and further described by the fields of Name 152 and Description 153. For example, a particular stage ‘1’ is named “R&D” and described as “emerging technology”. The field of PID 121 links this table to the Table PLAN 120. As seen in FIG. 9, the association identified by PID ‘1002’ is related to instances that exist in four stages: Stage 1—“R&D”, Stage 2—“Approved”, Stage 3—“Containment”, and Stage 4—“Retirement”. As mentioned above, each individual stage of the lifespan stage in which an instance exists is determined by the particular status of the instance in the environment status.

LIFESPAN STAGE

| StageNum | Name | Description | PID |
|---|---|---|---|
| 1 | ‘R&D’ | ‘emerging | 1002 |
| | | technology’ | |
| 2 | ‘Approved’ | | 1002 |
| 3 | ‘Containment’ | | 1002 |
| 4 | ‘Retirement’ | ‘end of life’ | 1002 |
| . . . | . . . | . . . | . . . |

7. Respective Stages in Lifespan Stage (IN_LIFESPAN STAGE 160)

The table of IN_LIFESPAN STAGE 160 further links an association to instances that respectively exist in individual stages of a lifespan stage. Similar to the table of IN_ENVIRONMENT STATUS 140, each data record in the instant table comprises a field of InstID 191 identifying an instance, the field of PID 121 identifying an association, and the field of StageNum 151 identifying an individual stage in which the instance exists. is referred by the. For example, the association ‘1002’ is related to an instance ‘879’ that exists in stage ‘2’ that is an “Approved” stage as referencing the table of LIFESPAN_STAGE 150.

IN_LIFESPAN_STAGE

| InsID | PID | StageNum |
|---|---|---|
| 879 | 1002 | 2 |
| . . . | . . . | . . . |

8. Lifespan Stage Term (LIFESPAN_TERM 170)

Below is a table of LIFESPAN_TERM 170 that defines a term length that an instance stays in a particular stage of the lifespan stage. It includes InstID 191 referencing an instance, StageNum 151 referencing a stage, and Length 171 specifying a term length that referred instance remains in the referred stage.

LIFESPAN_TERM

| | | Length |
|---|---|---|
| InstID | StageNum | (months) |
| 879 | 1 | 12 |
| 879 | 2 | 24 |
| 879 | 3 | 12 |
| 879 | 4 | 6 |
| . . . | . . . | . . . |

9. Date of Entry (LIFESPAN_STAGE_DOE 180)

The table of LIFESPAN_STAGE_DOE 180 that define a date of entry recording when an instance is defined to be entered into a particular stage of the lifespan stage. It includes InstID 191 referencing an instance, StageNum 151 referencing a stage, and Entry_Date 181 defining a date when the referred instance enters into the referred stage.

LIFESPAN_STAGE_DOE

| InstID | Entry_Date | StageNum |
|---|---|---|
| 879 | Jan. 7, 2003 | 1 |
| 879 | | 2 |
| 879 | | 3 |
| 879 | | 4 |
| . . . | . . . | . . . |

10. Instance (INSTANCE 190)

Below is a table of INSTANCE 190 including multiple instances. Each instance is identified by an InstID 191. It includes additional fields for more information in connection with the instance: ElmID 201 referencing an element defined in a table of ELEMENT 200, SpecID 211 referencing a specification defined in tables of SPECIFICATION 210 & SPEC 220, and STD 192 setting a flag that identifies whether an instance is set as an Enterprise Standard, a Plan standard (i.e. standard for an organization domain beneath the enterprise standard domain) matching the Enterprise Standard, a Plan Standard not matching the Enterprise Standard, or not a standard.

In the present system, an instance refers to a specific piece of IT asset that can be software, such as an operating system of Windows NT, Windows 98 or Windows 2000, or hardware and equipment, such as a mainframe server of IBM eServer z890, IBM eServer z900, or IBM eServer z990. Details of an instance are provided by referring to the following tables of ELEMENT 200, SPECIFICATION 210 & SPEC 220 and ASSET 230.

INSTANCE

| ID | ElmID | SpecID | STD |
|---|---|---|---|
| 879 | 98 | 895 | −1 |
| . . . | . . . | . . . | . . . |

11. Element (ELEMENT 200)

Below is a table of ELEMENT 200 comprising multiple elements. An element is defined to include basic information regarding an instance, such as a name and type of the instance. The table of ELEMENT 200 is almost equivalent to an element dictionary where each element is pre-defined for repetitive references. As seen in FIG. 14, each element is identified by ElmID 201, in conjunction with additional fields of Name 202, Type 203. For example, Element ‘98’ is software of ‘Windows 200’. More information regarding the instance containing Element ‘98’ can be retrieved from the tables of SPECIFICATION 210 & SPEC 220, as described below, using SpecID ‘356’.

ELEMENT

| ElmID | Name | Type | SpecID |
|---|---|---|---|
| 25 | ‘Windows NT 5.0’ | ‘Software’ | 120 |
| 97 | ‘Windows 98’ | ‘Software’ | 323 |
| 98 | ‘Windows 2000’ | ‘Software’ | 356 |
| . | . | . | . |
| . | . | . | . |
| . | . | . | . |

12. Specification (SPECIFICATION 210 & SPEC 220)

Below illustrates a table of SPECIFICATION 210, in which each data record includes a SpecID 211 and a Name 212 identifying a specification. This table provides an index or directory for user to look up for specific items associated with an instance in a separate table of SPEC 220. For instance, a specification ‘356’ comprises a first specific item named ‘Vendor’ with value of ‘Microsoft, Inc.’, a second specific item named ‘Family’ with value of ‘Microsoft OS’, a third specific item named ‘Cost’ with value of ‘$125’.

SPECIFICATION

| SpecID | Name |
|---|---|
| 356 | ‘Windows 2000’ |
| 488 | ‘Mid Level PC’ |
| 895 | |
| . | . |
| . | . |
| . | . |

More specifically, as seen below, the field of Name 221 defines what a specific item represents, Value 222 defines the value of the corresponding specific item, and Type 223 is a flag identifying whether the specific item is an element level, an instance level or an element/instance level. The type of a specific item determines whether a user can overide and re-define this specific item as part of a specification for the related instance. A specific item at the element level is almost like an element representing pre-defined information for universal use. If a specific item is in an instance level, it is likely to be modified and re-defined by users based upon their respective needs. Take an instance that includes Element ‘98’ for example. Based upon the exemplary data in FIGS. 14, 15a-b, this instance contains an element of “Windows 2000”, which is provided by a vendor of “Microsoft, Inc.”, belongs to the family of “Microsoft OS”, and has a cost of “$125”. However, it may cost a particular user more than $125 to acquire “Windows 2000”. Thus, this particular user can change the value for Cost 221. It is also possible that a user needs to include additional information regarding to this particular “Windows 2000”, e.g., the user can add into the specification ‘356’ a specific item named ‘acquisition type’ with value of ‘purchase’ or ‘lease’.

SPEC

| Name | Value | SpecID | Type |
|---|---|---|---|
| ‘Vendor’ | ‘Microsoft, Inc.’ | 356 | −1 |
| ‘Family’ | ‘Microsoft OS’ | 356 | −1 |
| ‘Cost’ | ‘$ 125’ | 356 | 0 |
| ‘RAM’ | ‘256’ | 488 | 0 |
| ‘Cost’ | ‘$ 110’ | 895 | 0 |
| . | | . | . |
| . | | . | . |
| . | | . | . |

13. Asset (ASSET 230)

Below is a table ASSET 230 recording asset serial numbers in connection with instances. A Serial 231 is a unique identifier for a particular IT asset. Typically, it is assigned by the manufacturer to each individual product, even of the same type. One example is, as illustrated in FIGS. 14-16, an Instance ‘879’ includes an Element ‘98’, “Windows 2000”, which may contain a set of Windows 2000 operating systems having respective serial numbers ‘15BX-235-XCV’, ‘5626-s5d-rt5’, ‘g5dd-y83-987’, ‘erre-678-985’, etc. This table provides details to the extent that every single piece of asset will be visible to the user in the system.

ASSET

| Serial | InstID |
|---|---|
| ‘15BX-235-XCV’ | 879 |
| ‘5626-s5d-rt5’ | 879 |
| ‘g5dd-y83-987’ | 879 |
| ‘erre-678-985’ | 879 |
| . | . |
| . | . |
| . | . |

14. Additional Data Links (DEPENDS_ON, HIGHEST_LEVEL, USER_ORG_LEVEL, EXCLUDED_TECH)

Besides the above-discussed data components, the system includes additional data links that further define relations between these data components. These data links are illustrated in FIGS. 17a-d and will be described in detail below.

a. Elements and Specifications (DEPENDS_ON 240)

The table of DEPENDS_ON 240 defines the dependencies that may exist between two elements, an element and a specification, or two specifications. Thus, DependantID 241 can be an ElmID 201 or a SpecID 211, and so is DependeeID 243. Dependence_Type 242 is a flag identifying the type of dependency, e.g., Exclusion, Requires, Pair-wise. As shown in FIG. 17a, Element ‘98’, “Windows 2000”, is dependent on Specification ‘488’, a “Mid-level PC”. More specifically, to operate “Windows 2000” requires a “Mid-level PC”.

DEPENDS_ON

| DependantID | | DependeeID |
|---|---|---|
| (ElmID) | Dependence_Type | (SpecID) |
| 98 | −1 | 488 |
| . | . | . |
| . | . | . |
| . | . | . |

b. Element v. IT Architectural Taxonomy (HIGHEST_LEVEL 250)

The table of HIGHEST_LEVEL 250 defines the highest level in the IT architectural taxonomy that an element is allowed to be visible to a user. As data integrity mechanism, this is to ensure that elements in various instances will be associated with the appropriate IT architectural domains. For example, Element ‘98’, “Windows 2000” will be visible in the architectural Domain ‘1.1.2’, which is an “operating system” by referring to the table of Arch_Domain 110, and all domains subsidiary to Domain ‘1.1.2’. In other words, instances related to Domain ‘1.1.2’ and its sub domains may contain Element ‘98’, but instances related to any other domains shall not contain Element ‘98’. Basically, this table is used as a filter so that a user need not scroll through a list of all Elements when entering data into associations/plans. If the user is choosing items to place in an association involving Arch domain ‘operating systems’ they will not have to view irrelevant elements.

HIGHEST_LEVEL

| ElmID | TID |
|---|---|
| 25 | ‘1.1.2’ |
| 97 | ‘1’ |
| 98 | ‘1.1.2’ |
| . | . |
| . | . |
| . | . |

c. User v. Organization Taxonomy (USER ORG_LEVEL 260)

The table of USER_ORG_LEVEL 260 defines different users' accessibilities to the organization taxonomy. This is a security mechanism for data management. Each user of the system is identified by UserID 261. Upon validation of the identity of a user, the system determines the highest level of domain in the organization taxonomy to which the user has access. An enterprise system administrator is able to view all of the domains in the entire organizational taxonomy and modify instances related to these domains. For users from lower levels of the enterprise, it is not desirable for them to modify or view information related to domains above their levels. In this table, Type 262 further specifies a user's access to a domain, e.g., View Only, Modify.

USER_ORG_LEVEL

| UserID | OID | Type |
|---|---|---|
| ‘Bob Smith’ | ‘3.1’ | 0 |
| ‘Dave Smith’ | ‘3.1.2’ | 0 |
| . | . | . |
| . | . | . |
| . | . | . |

d. Organization Taxonomy v. IT Architectural Taxonomy (EXCLUDED_TECH 270)

The table of EXCLUDED_TECH 270 excludes certain IT architectural domains from being display for selection after an organization domain is selected. Most likely, some sub entities of an enterprise will never possess certain IT architectural elements in the IT architectural taxonomy. In that regard, the identified organization domain will not be related to certain IT architectural domains. When displaying the IT architectural taxonomy to the user having access to a certain organization domain and its domains, it is desirable to block unrelated architectural domains from the user's view so as to avoid confusion or errors in selection. Type 271 in this table defines how some of the architectural domains will be filtered, e.g., Hidden, View-Only.

EXCLUDED_TECH

| OID | TID | Type |
|---|---|---|
| ‘3.1.2’ | ‘1.2’ | −1 |
| . | . | . |
| . | . | . |
| . | . | . |

System Functionalities

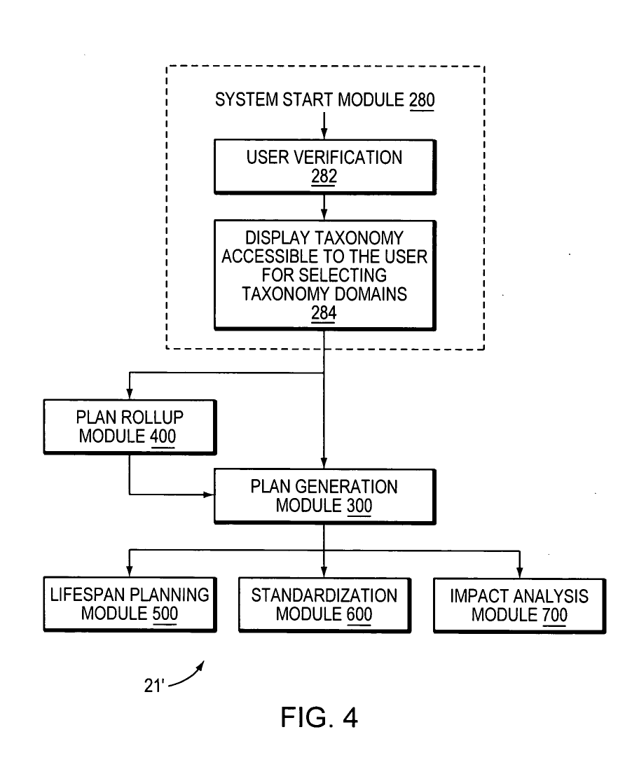

Additional features of the above-explained system components will be further described in the following system application modules 21′ as illustrated in FIG. 4. The system comprises a System Start Module 280, Plan Generation Module 300, Plan Rollup Module 400, Lifespan Planning Module 500, Standardization Module 600 and Impact Analysis Module 700. The System Start Module 280 starts with a step of User Verification 282 where a user logs into the system after inputting valid username and/or password. Based upon the user's identity, the system determines the user's access to the organization taxonomy in accordance with the table of USER_ORG_LEVEL 260. Subsequent to that determination, the system further determines the IT architectural domains visible to the user with reference to the table of EXCLUDED_TECH 270. Then the system will display the taxonomies accessible to the user for selecting a particular organization domain and an IT architectural domain.

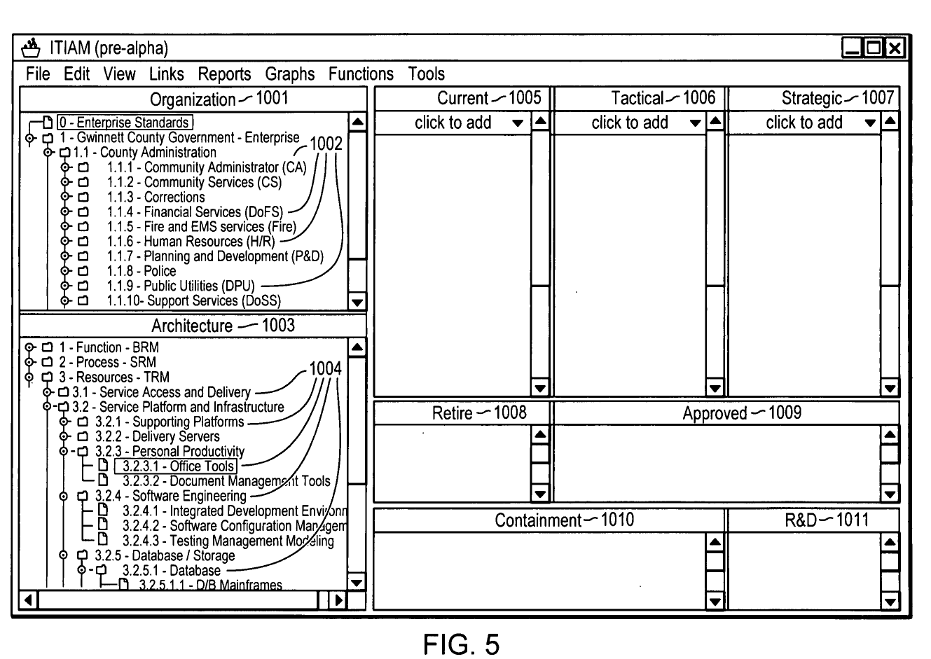

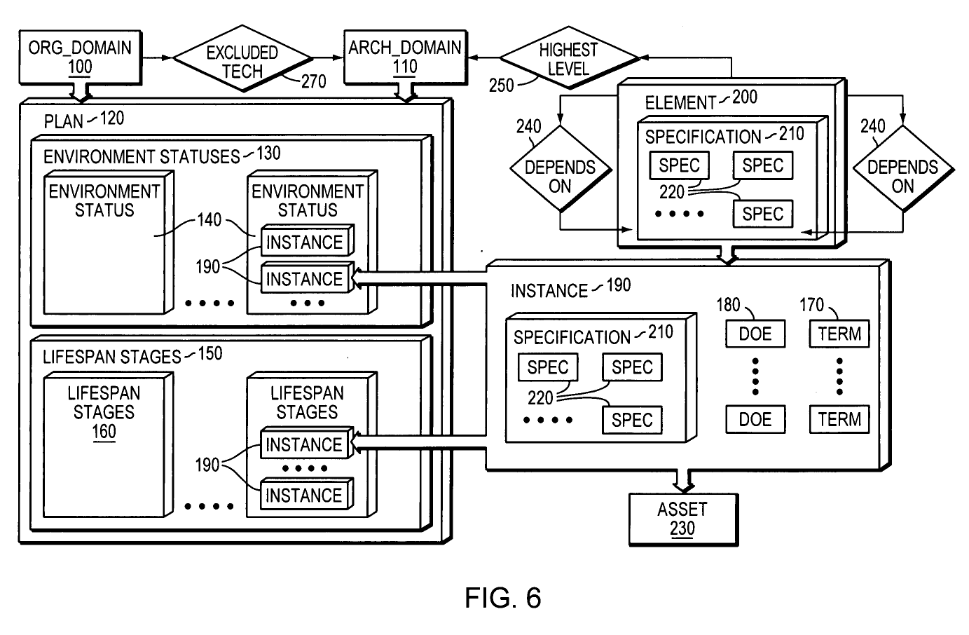

FIG. 5 shows an exemplary screen display for domain selection. As seen in this figure, a user is provided with a hierarchical taxonomy of Organization 1001 comprising a plurality of organizational domains 1002, and a hierarchical taxonomy of Architecture 1003 comprising a plurality of architectural domains 1004. The user is also provided with a display of the environment status of Current 1005, Tactical 1006 and Strategic 1007, and the lifespan stage of Retire 1008, Approved 1009, Containment 1010 and R&D 1011. After the user selects a particular organizational domain and a particular architectural domain, one or more instances related to both domains will be identified and listed in this display. This process is the Plan Generation Module 300 that is detailed in FIG. 6.

1. IT Information Organization and Visibility

a. Association/Plan Generation and Display

FIG. 6 illustrates the process of generating an association between selected domains and further identifying instances related to the association and displaying their related environment status, lifespan stage and other information. The first step is to identify the user-selected domains from the table of ORG_DOMAIN 100 and the table of ARCH_DOMAIN 110. Then the system associates the identified organization domain with the identified architectural domain to create a record in Plan 120. The created association will be related to both the table of ENVIRONMENT_STATUS 130 that is composed of individual statuses, and the table of LIFESPAN_STAGE 150 that is composed of individual stages. For each individual status, the system looks up for instances existing therein from the table of IN_ENVIRONMENT STATUS 140. Further, based upon the specific status in which an instance exists, the system determines a stage for the instance from the table of IN_LIFESPAN STAGE 160. In addition, more information regarding any identified instances will be provided as the system locates their related stage terms from the table of LIFESPAN_TERM 170, dates of entry from the table of LIFESPAN_STAGE_DOE 180, elements from the table of ELEMENT 200, specifications from the tables of SPECIFICATION 210 & SPEC 220, and even asset serial numbers from the table of ASSET 230. It would be appreciated by a person of ordinary skill that the above-mentioned tables detailing instance information may already exist in other information management systems, such as an IT asset management system, or is pre-defined like an encyclopedia for universal references. The present system can be configured to access pre-existing databases containing these tables by means of appropriate API (Application Programmable Interfaces). This provides users significant advantages to maximize an employment of existing data and avoid data redundancy.

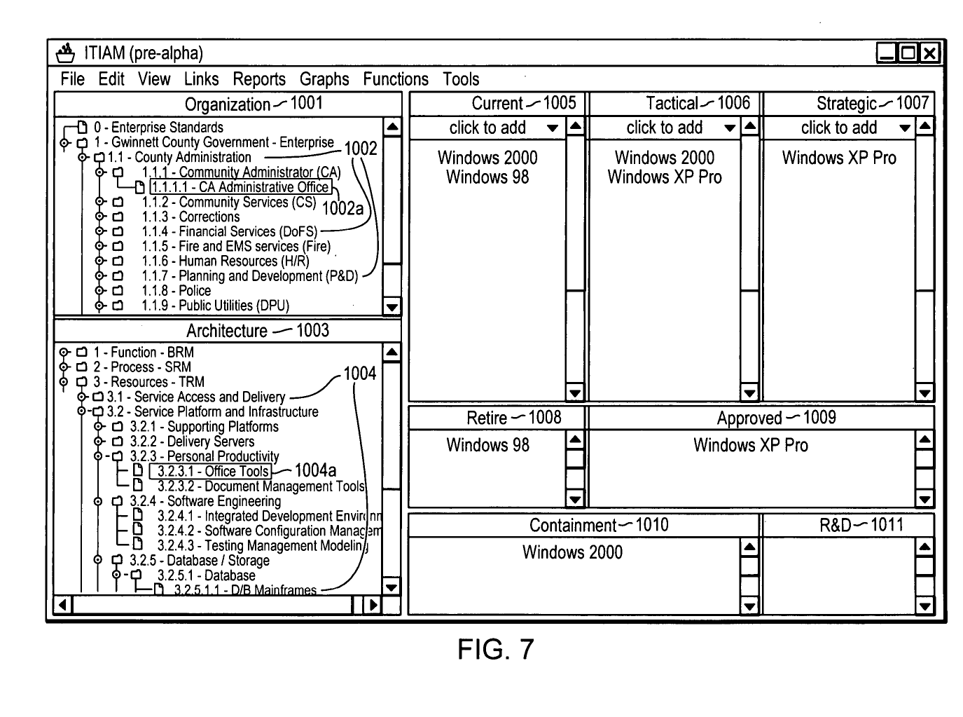

In FIG. 7, an organization domain 1002a, namely ‘1.1.1.1’—“CA Administrative Office”, and an architectural domain 1004a, namely ‘3.2.3.1’—“Office Tools” are selected. The generated plan or association is then displayed in the right of the window. Specifically, it shows that “Office Tools” belonging to “CA Administrative Office” includes a “Windows 2000” whose status in the environment is both “Current” and “Tactical”, a “Windows 98” whose status in the environment is “Current” and a “Windows XP Pro” whose status in the environment is both “Current” and “Strategic”. Accordingly, this “Windows 2000” has a lifespan stage of “Containment”, the “Windows 98” has a lifespan stage of “Retire”, and the “Windows XP Pro” has a lifespan stage of “Approved”.

b. Association/Plan Rollup

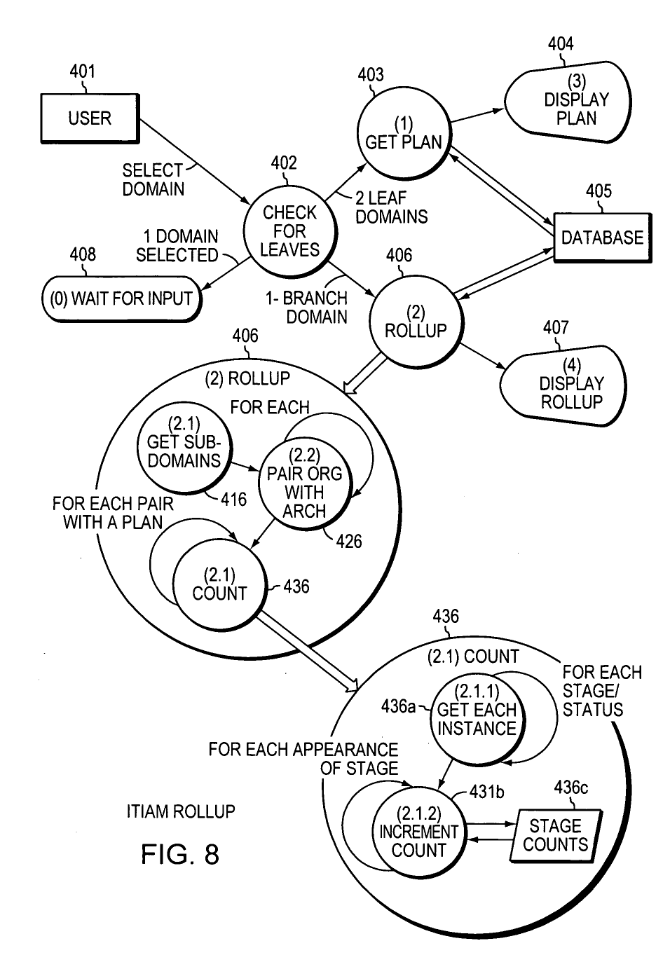

It is noted in the above example in FIG. 7, the selected domains are both leaf domains in their respective taxonomy hierarchies and their relationship is a one-to-one association. In other words, the system displays what “Office Tools” is used by “CA Administrative Office” and the related status and stage information. But what if a user selects an organization domain that is a branch domain, i.e., a domain containing multiple sub domains? For example, the user selects an organization domain ‘1’—“Gwinnett County Government—Enterprise”, which contains a number of sub domains. Each sub domain may be directly associated with the architectural domain ‘3.2.3.1’—“Office Tools” to locate information such as what “Office Tools” is used each sub entities. In addition, the system can provide certain statistics for the “Gwinnett County Government—Enterprise”, e.g, how many types of “Office Tools” in total are used by all of the sub entities beneath the “County Administrator”. FIG. 8 shows this plan rollup process.

As seen in FIG. 8, after a user 401 selects domains, the system will check whether the domains are both leaf domains in the step of 402. If so, the module of Get Plan 403 will be initiated, in accordance with the process flow as explained above (See FIG. 20), by retrieving data from Database 405 as illustrated in FIG. 3 and then displaying the data in the module of Display Plan 404. If the system determines at least one selected domain is a branch domain, a module of Rollup 406 will be triggered.

Assuming the branch domain is the organization domain, the first step 416 in this Rollup Module 406 is to get sub-domains of the organization domain. Then, in Step 426 the system pairs each sub-domain with the architectural domain to generate an association/plan. For each generated association/plan, the system performs a Count Step 436. This Count Step 436 comprises the steps of getting each instance for each association/plan via the environment and lifespan tables (436a), incrementing counts for instances that have the same element or specification (436b), and recording and displaying the counts in different environment statuses and lifespan stages (436c).

The counts as a result of this Rollup Module 406 are demonstrated in the exemplary screen display in FIG. 9. It can be seen that “Office Tools” used by entities subsidiary to “Gwinnett County Government—Enterprise” include one “Windows 98” in the “Current” status and “Retire” stage, one “Windows 2000” in both “Current” and “Tactical” status and thus “Containment” stage, one “Windows XP Pro” in both “Strategic” and “Tactical” status and thus “Approved” stage.

2. Lifespan Planning

Besides displaying organized IT asset information (i.e., instances) that is related to both taxonomies, the present system allows a user to update and modify data relating to certain instances for planning retirement of current IT assets and/or introduction of emerging technology strategically. As exemplified in FIG. 7, a user may add an instance related to the selected organization domain in association with the selected architectural domain under a specific status in the environment. By double-clicking a displayed instance, moreover, a user will see a prompt screen display 1200, which shows detailed information regarding the selected instance so that the user is able to edit the data.

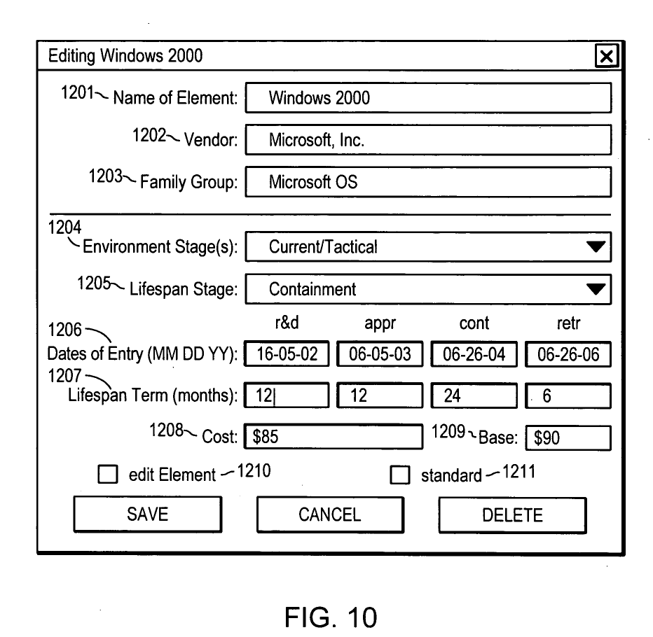

In the prompt screen display in FIG. 10, the displayed instance contains an element named “Windows 2000” 1201, from a vendor 1201 of “Microsoft, Inc” and belonging to the Family Group 1203 of “Microsoft OS”. This instance exists in the “current/tactical” status of the environment status 1204 and thus has a lifespan stage 1205 of “containment”. 1206 Normal Stage Terms defines the term length that an instance remains within respective stages of a lifespan stage, and here, 12 months in the R&D stage, 24 months in Approved stage, 12 months in Containment stage and 12 months in Retirement stage. These terms can be pre-defined with default values, or be edited by the user. In fact, a user can increase or decrease Normal Stage Terms 1206 so as to control the term length that a particular asset stays in a particular stage. In this way, the user can determine how soon a particular asset in the current status will be retired and how soon an emerging technology in the strategic status should be introduced into the organization as a mainstream product. Corresponding to respective stages, there are respective Dates of Entry 1207 recording when an IT asset is changed into one particular stage. Without user interruption, the system automatically assigns a date as Date of Entry based upon the Normal Stages Terms. A Cost 1208 and A Base 1209 for acquiring the IT asset can also be shown in this prompt window.

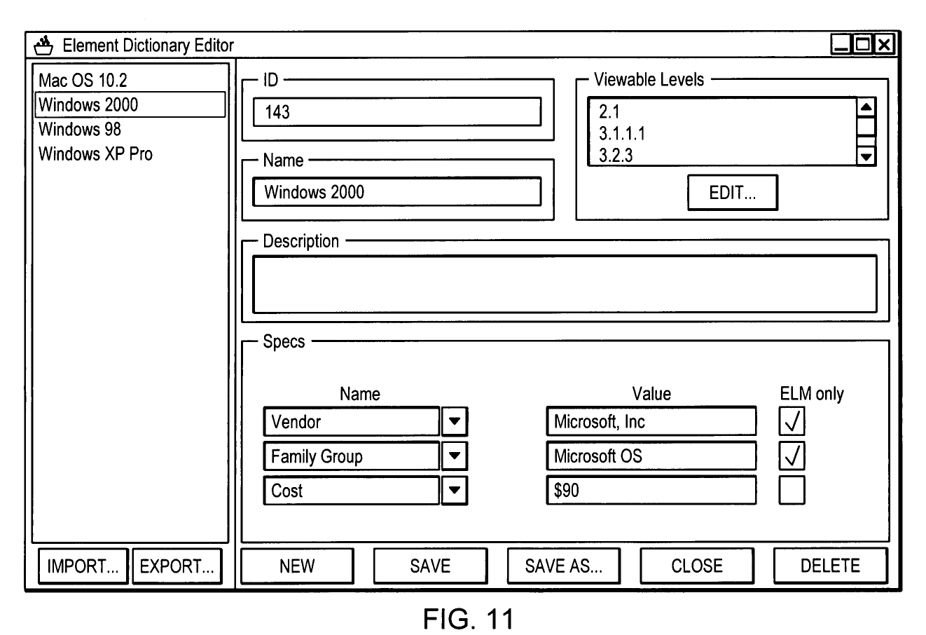

What is displayed in the various parts of the Instance Edit window: Name, DOEs, terms are always displayed as they exist for all instances (although DOEs and terms may be blank) below ‘Name’ are all ELM only specs, that may only be changed by editing the element. Below DOEs and terms are all Elm/INST specs that may be edited for each instance, but which have default values pulled from the Element the instance relates to. Thus, additional/differing specs from ‘Vendor’, ‘Cost’ may be displayed on this screen. If a user decides to change element information, he can select “edit element” 1210 to trigger a prompt window in FIG. 11. As seen in this figure, a user can edit the element as needed, or even define instance-related data to be ELM only specs.

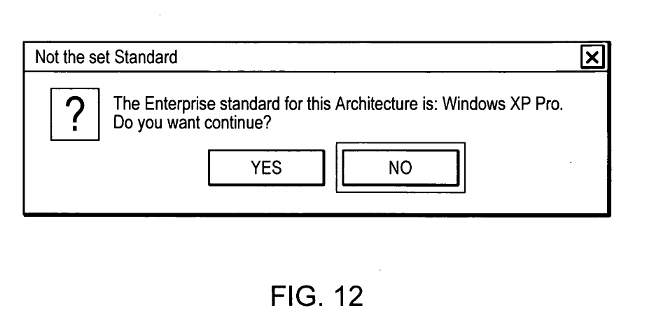

If the user decides to set the instance as standard, he can select “Standard” 1211. Then a prompt window as shown in FIG. 12 will be displayed to remind the user of the Enterprise Standard if the selected instance information is different from the pre-defined Enterprise Standard. The user can ignore the notice and set the selected instance as standard. The standard setting process will be described in detail below.

3. Standardization

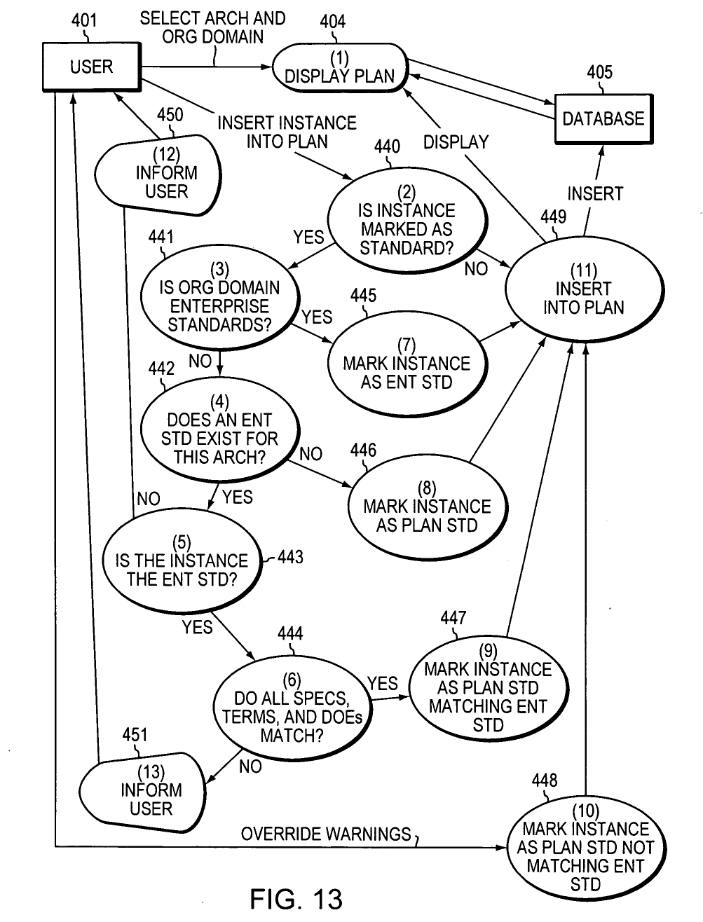

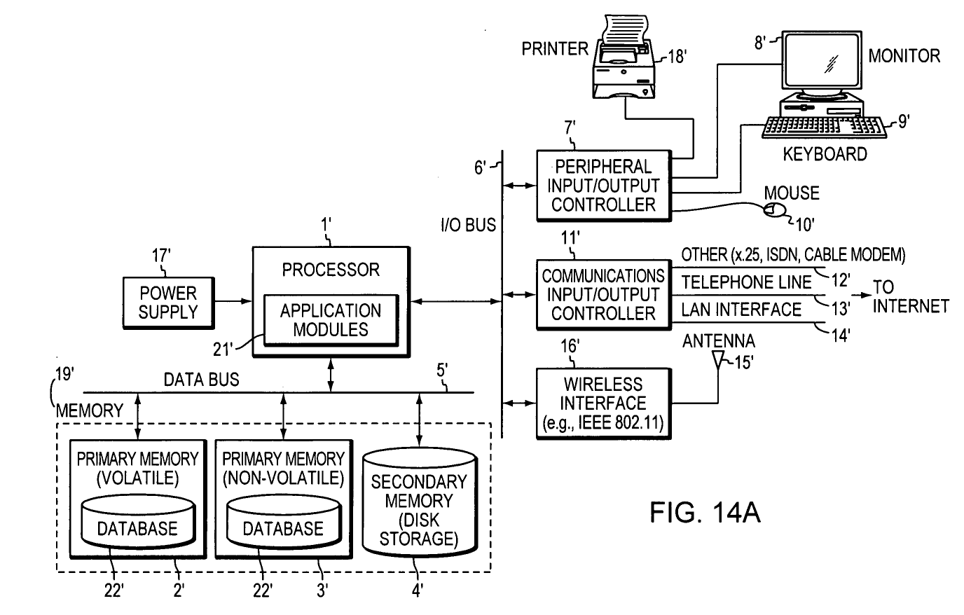

Another important functionality of the present system is to set IT standards for the entire enterprise IT architecture. The work flow of this standardization functionality is illustrated in FIG. 13. Normally, a User 401 is allowed to select the organization domain and architectural domain so that the system would search the Database 405 and Display Plan 404. As shown in FIG. 24, a User 401 may also be allowed to add or insert an instance into a plan/association. Once the system receives user input regarding the instance to be inserted from a prompt display window, Step 440 determines whether the instance is marked Standard. If not, the instance will be inserted into the Plan as instructed in Step 449. If the instance is marked as standard, Step 441 continues to determine whether the organization domain in this association is the enterprise standard domain in the organization taxonomy hierarchy. If so, the instance will be marked as Enterprise Standard in Step 445 and inserted into the plan in Step 449. If not, Step 442 asks whether an enterprise standard exists for this architectural domain. If not, the system marks the instance as a Plan Standard according to Step 446 and then inserts it into the plan in Step 449. If an Enterprise Standard already exists for this architectural domain, the system determines whether the instance to be inserted is the same as the Enterprise Standard pursuant to Step 443. If not, an alert or warning will be sent to in Step 450, informing the user that the instance to be inserted is not matching the Enterprise Standard. If the instance is the same as the Enterprise Standard, the system goes further to check if all specifications, terms and dates of entries of the instance match the enterprise standard. Again, if not, the user will be informed in Step 451. Otherwise the instance will be marked as plan standard matching Enterprise Standard in Step 447 and inserted into Plan. The User 401 may override all warnings sent in Step 450 or Step 451 and confirm with the system to mark the instance as Plan standard although it is not matching the Enterprise Standard.

4. Other Specific Functionalities: Impact Analysis and Total Cost Control

As can be readily appreciated, many additional functions can be accomplished based upon the above-described methods for information organization and management. One significant advantage of the system is its great flexibility in being configured to accommodate user-specific needs with ease. For example, an enterprise CIO may need to be aware of any impact upon each department before deciding to entirely retire one type of IT asset throughout the enterprise. As noted above, the CIO will be provided with information visibility into each individual department's deployment of IT assets. Given the relatedness of various data, furthermore, the CIO may view how one department's decision to retire certain types of assets may trigger its own needs to acquire other assets, or how one department's decision to retire certain types of assets may trigger another department's needs to acquire other assets. The system can be configured for keeping track of any information change to generate impact analyses and reports.

Those skilled in the art of data networking will realize that many other alternatives and architectures are possible and can be used to practice the principles of the present invention. The embodiments illustrated in FIGS. 1a and 1b can be modified in different ways and be within the scope of the present invention as claimed.

Another example is to generate reports of cost. As described above, a user can view the cost of each piece of IT item. The system can be further configured to calculate the total IT-related cost for the entire enterprise or a particular department. With highly visible information, the CIO of an enterprise is capable of controlling the total cost of the entire IT architecture by monitoring each individual department.

As can be appreciated by a skilled artisan, the above-mentioned functions of impact analysis and cost control, among many other possible functions, can be easily added to the system in reliance upon the existing basic functions of information management.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method for information management involving taxonomy and lifespan planning, said method comprising the steps of:
allowing a user to select a first taxonomy domain from a first hierarchical classification system, said first hierarchical classification system comprising a first set of taxonomy domains in various tiers of a first taxonomy;
receiving said first taxonomy domain from said user;
allowing said user to select a second taxonomy domain from a second hierarchical classification system, said second hierarchical classification system comprising a second set of taxonomy domains in various tiers of a second taxonomy;
receiving said second taxonomy domain from said user; and
in response to receiving said first taxonomy domain and said second taxonomy domain, generating an association between said first taxonomy domain and said second taxonomy domain, said association relating to one or more instances,
wherein,
each of said one or more instances is defined by an element and a specification, and said one or more instances are identified through the steps of:
generating an environment status for said association, said environment status comprising one or more statuses,
generating a lifespan stage for said association, said lifespan stage comprising one or more stages, said one or more stages corresponding to said one or more statues of said environment status,
for each of said one or more statuses of said environmental status, determining whether an instance related to said association exists in said status,
responsive to the determination that said instance exists in said status, selecting, from said one or more stages of said lifespan stage, a stage for said instance based in part upon said status, and
further identifying a stage term and a date of entry for said instance in said stage.

2. The method of claim 1, wherein said first taxonomy is an organization comprising one selected from the group of an enterprise, a corporation, a non-profit association, a government department or any other entities, and said first hierarchical classification system comprises organizational components in various tiers within said organization.

3. The method of claim 1, wherein said second taxonomy is Information Technology (IT) architecture and said second hierarchical classification system comprises architectural components in various tiers of said Information Technology (IT) architecture.

4. The method of claim 1, wherein each of said first set of taxonomy domains is related to at least a super domain or a sub-domain in said first taxonomy, and each of said second set of taxonomy domains is related to at least a super domain or a sub-domain in said second taxonomy.

5. The method of claim 1, wherein said association comprises a plan that associates said first taxonomy domain with said second taxonomy domain, said plan presenting said environment status and said lifespan stage related to said one or more instances to said user.

6. The method of claim 1, wherein said element is selected from an element dictionary comprising a plurality of elements, each of said plurality of elements containing basic information relating to each of said one or more instances.

7. The method of claim 1, wherein said specification is selected from a specification dictionary comprising a plurality of specifications, each of said plurality of specifications containing additional information relating to each of said one or more instances, said specification dictionary configurable pursuant to said user's needs.

8. The method of claim 1, wherein said environment status comprises a first status identifying that any instances in said first status are in current use.

9. The method of claim 8, wherein said environment status further comprises a second status identifying that any instances in said second status will keep in a tactical use.

10. The method of claim 9, wherein said environment status further comprises a third status identifying that any instances in said third status will come into use in a strategic plan.

11. The method of claim 8, wherein said lifespan stage comprises a first stage corresponding to said first status, wherein said first stage will be selected for each of said any instances in said first status, and said first stage shows that said any instances in said first status are in a retirement stage.

12. The method of claim 9, wherein said lifespan stage further comprises a second stage corresponding to both said first status and said second status, wherein said second stage will be selected for each of said any instances in both said first status and said second status, and said second stage shows that said any instances in both said first status and said second status are in a containment stage.

13. The method of claim 10, wherein said lifespan stage further comprises a third stage corresponding to both said second status and said third status, wherein said third stage will be selected for each of said any instances in both said second status and said third status, and said second stage shows that said any instances in both said second status and said third status are an approved stage.

14. The method of claim 10, wherein said lifespan stage further comprises a fourth stage corresponding to said third status, wherein said third stage will be selected for each of said any instances in said third status, and said fourth stage shows that said any instances in said third status are in an Research & Development (R&D) stage.

15. The method of claim 1, further comprising:
displaying to said user said one or more instances in said environment status and said lifespan stage.

16. The method of claim 1, further comprising:
allowing said user to select a particular instance from said one or more instances;
displaying to said user information relating to said particular instance, said information including a particular element, a particular specification, a particular environment status, a particular lifespan stage and related stage terms and dates of entry; and
allowing said user to modify said information relating to said particular instance.

17. A system for information management involving taxonomy and lifespan planning, said system comprising:
a data storage device configured to include at least a database; and
a processor having access to said database, said processor configured to perform the steps of:
receiving a first user input, said first user input comprising a first taxonomy domain selected from a first hierarchical classification system, said first hierarchical classification system comprising a first set of taxonomy domains in various tiers of a first taxonomy;
receiving a second user input, said second user input comprising a second taxonomy domain selected from a second hierarchical classification system, said second hierarchical classification system comprising a second set of taxonomy domains in various tiers of a second taxonomy;
in response to receiving said first taxonomy domain and said second taxonomy domain, generating an association between said first taxonomy domain and said second taxonomy domain, said association relating to one or more instances, each of said one or more instances including at least an element and a specification;
identifying said one or more instances from said database through the steps of:
(A) generating an environment status for said association, said environment status comprising one or more statuses,
(B) generating a lifespan stage for said association, said lifespan stage comprising one or more stages, said one or more stages corresponding to said one or more statues of said environment status,
(C) for each of said one or more statuses of said environmental status, determining whether an instance related to said association exists in said status,
(D) responsive to the determination that said instance exists in said status, selecting, from said one or more stages of said lifespan stage, a stage for said instance based in part upon said status, and
(E) further identifying a stage term and a date of entry for said instance in said stage.

18. The system of claim 17, wherein said processor is further configured for:
displaying said one or more instances existing in said environment status and said lifespan stage.

19. The system of claim 17, wherein said processor is further configured for:
allowing a user to select a particular instance from said one or more instances;
displaying to said user information relating to said particular instance, said information including a particular element, a particular specification, a particular environment status, a particular lifespan stage and related stage terms and dates of entry; and
allowing said user to modify said information relating to said particular instance.

20. A method for managing information associated with different taxonomies, said method comprising the steps of:
allowing a user to select a first taxonomy domain from a first taxonomy, and further select a second taxonomy domain from a second taxonomy;
responsive to receiving said first taxonomy domain and said second taxonomy domain, determining whether neither said first taxonomy domain nor said second taxonomy domain has sub-domains, and
if so, searching a database storing data regarding a plurality of instances to identify one or more instances relating to an association between said first taxonomy domain and said second taxonomy domain and display said one or more instances in an environment status and a lifespan stage; and
otherwise, triggering a rollup application prior to displaying any instances relating to said association between said first taxonomy domain and said second taxonomy domain.

21. The method of claim 20, wherein said rollup application comprises:
identifying a set of sub-domains of said first taxonomy domain;
associating each of said set of sub-domains with said second taxonomy domain to create a set of sub-associations;
for each of said set of sub-associations, searching said database to identify instances relating to said sub-association;
categorizing said instances into several groups of instances based upon a specific item, each of said groups having the same value of said specific item; and
incrementing counts for each of said several groups of instances.

22. The method of claim 20, wherein said first taxonomy is an organization comprising one selected from the group of an enterprise, a corporation, a non-profit association, a government department or any other entities.

23. The method of claim 20, wherein said second taxonomy is Information Technology (IT) architecture.

25. The method of claim 20, wherein each of said plurality of instances is defined by at least an element and a specification,
said element selected from an element dictionary comprising a plurality of elements, each of said plurality of elements containing basic information relating to each of said plurality of instances,
said specification selected from a specification dictionary comprising a plurality of specifications, each of said plurality of specifications containing additional information relating to each of said plurality of instances, said specification dictionary configurable pursuant to said user's needs.

26. The method of claim 20, wherein said one or more instances are identified through the steps of:
generating said environment status for said association, said environment status comprising one or more statuses;
generating said lifespan stage for said association, said lifespan stage comprising one or more stages, said one or more stages corresponding to said one or more statues of said environment status;
for each of said one or more statuses of said environmental status, determining whether an instance related to said association exists in said status;
responsive to the determination that said instance exists in said status, selecting, from said one or more stages of said lifespan stage, a stage for said instance based in part upon said status; and
further identifying a stage term and a date of entry for said instance in said stage.

27. The method of claim 20, further comprising:
allowing said user to select a particular instance from said one or more instances identified from said database;
displaying to said user information relating to said particular instance, said information including a particular element, a particular specification, a particular environment status, a particular lifespan stage and related stage terms and dates of entry; and allowing said user to modify said information relating to said particular instance.

28. An information management system for associating different taxonomies, said system comprising:
a data storage device configured to include at least a database, said database storing data relating to a plurality of instances, each of said plurality of instances defined by an element in conjunction with a specification;
a processor having access to said database, said processor configure for:
receiving a user input comprising a first taxonomy domain from a first taxonomy and a second taxonomy domain from a second taxonomy;
responsive to receiving said first taxonomy domain and said second taxonomy domain, determining whether neither said first taxonomy domain nor said second taxonomy domain has sub-domains;
responsive to the determination that neither domain has sub-domains, searching said database to identify one or more instances relating to an association between said first taxonomy domain and said second taxonomy domain;
responsive to the determination that at least said first taxonomy domain has sub-domains, identifying a set of sub-domains of said first taxonomy domain;
associating each of said set of sub-domains with said second taxonomy domain to create a set of sub-associations;
for each of said set of sub-associations, searching said database to identify instances relating to said sub-association;
categorizing said instances into several groups of instances based upon a specific item, each of said groups having the same value of said specific item; and
incrementing counts for each of said several groups of instances.

29. The system of claim 28, wherein said processor is further configured for:
displaying said one or more instances identified from said database in an environment status and a lifespan stage, said environment status comprising one or more statuses, said lifespan stage comprising one or more stages, each of said one or more stages determined based in part upon said one or more statuses of said environment status, and further corresponding to a stage term and a date of entry.

30. The system of claim 29, wherein said processor is further configured for:
allowing a user to select a particular instance from said one or more instances;
displaying to said user information relating to said particular instance, said information including a particular element, a particular specification, a particular environment status, a particular lifespan stage and related stage terms and dates of entry; and
allowing said user to modify said information relating to said particular instance.

31. A method of standardization for information management, said method comprising the steps of:
allowing a user to select a first taxonomy domain from a first information taxonomy and a second taxonomy domain from a second information taxonomy;
identifying and displaying one or more instances from a database storing data for a number of instances, said one or more instances relating to an association between said first taxonomy domain and said second taxonomy domain;
allowing said user to insert an additional instance as related to said association;
determining whether said additional instance is marked by said user as standard, and if not, inserting said additional instance into said database as related to said association;
(A) responsive to the determination that said additional instance is marked as standard, further determining whether said first taxonomy domain is a first standard domain of said first information taxonomy, and if so, marking said additional instance as a first standard for said second taxonomy domain prior to inserting said additional instance into said database as related to said association; and
(B) responsive to the determination that said first taxonomy domain is not said first standard domain of said first information taxonomy, determining whether said first standard exists for said second taxonomy domain,
(1) responsive to the determination that said first standard does not exist for said second taxonomy domain, marking said additional instance as a second standard for said second taxonomy domain prior to inserting said additional instance into said database as related to said association, and
(2) responsive to the determination that said first standard exists for said second taxonomy domain, determining whether said additional instance matches said first standard,
(a) responsive to the determination that said additional instance matches said first standard, marking said additional instance as a third standard matching said first standard for said second taxonomy domain prior to inserting said additional instance into said database as related to said association, and
(b) responsive to the determination that said additional instance does not match said first standard, alerting to said user that said additional instance does not match said first standard.

32. The method of claim 31, further comprising the step of:
receiving a confirmation from said user that said additional instance is to be inserted regardless of its not matching said first standard; and
marking said additional instance as a fourth standard not matching said first standard prior to inserting said additional instance into said database as related to said association.

33. The method of claim 31, wherein said first information taxonomy comprises a hierarchy of multiple taxonomy domains, each of said multiple taxonomy domains having at least one from the group of a super domain and a sub-domain.

34. The method of claim 31, wherein said second information taxonomy comprises a hierarchy of multiple taxonomy domains, each of said multiple taxonomy domains having at least one from the group of a super domain and a sub-domain.

35. The method of claim 31, wherein each of said number of instances is defined by at least an element and a specification, wherein,
said element selected from an element dictionary comprising a plurality of elements, each of said plurality of elements containing basic information relating to each of said plurality of instances, and
said specification selected from a specification dictionary comprising a plurality of specifications, each of said plurality of specifications containing additional information relating to each of said plurality of instances, said specification dictionary configurable pursuant to said user's needs.

36. The method of claim 35, wherein said one or more instances are identified through the steps of:
generating said environment status for said association, said environment status comprising one or more statuses;
generating said lifespan stage for said association, said lifespan stage comprising one or more stages, said one or more stages corresponding to said one or more statues of said environment status;
for each of said one or more statuses of said environmental status, determining whether an instance related to said association exists in said status;
responsive to the determination that said instance exists in said status, selecting, from said one or more stages of said lifespan stage, a stage for said instance based in part upon said status; and
further identifying a stage term and a date of entry for said instance in said stage

37. A method of impact analysis for information management, said method comprising the steps of:
(A) identifying a first instance related to a first association between a first organizational taxonomy domain with a first architectural taxonomy domain;
(B) displaying information regarding said first instance for a user input to modify said information, said information including an element, an specification, an environment status, a lifespan stage and related stage terms and dates of entry in connection with said first instance;
(C) modifying said first instance based upon said user input;
(D) identifying a second instance related to a second association between a second organizational taxonomy domain with a second architectural taxonomy domain;
(E) determining a change in said second instance as a result of modifying said first instance; and
(F) generating a report including said modification of said first instance and said change in said second instance.

38. The method of claim 37, wherein said first instance and said second instance are identified from a plurality of instances stored in a database, each of said plurality of instances relating to one of a plurality of associations between an organizational taxonomy comprising a plurality of organization taxonomy domains and an architecture taxonomy comprising a plurality of architecture taxonomy domains.

39. The method of claim 37, wherein said first instance is identified through the steps of:
generating said environment status for said first association, said environment status comprising one or more statuses;
generating said lifespan stage for said association, said lifespan stage comprising one or more stages, said one or more stages corresponding to said one or more statues of said environment status;
for each of said one or more statuses of said environmental status, determining whether an instance related to said association exists in said status;
responsive to the determination that said instance exists in said status, selecting, from said one or more stages of said lifespan stage, a stage for said instance based in part upon said status; and
further identifying said stage term and said date of entry for said instance in said stage.

40. The method of claim 37, wherein said element is selected from an element dictionary comprising a plurality of elements, each of said plurality of elements containing basic information relating to each of said plurality of instances.

41. The method of claim 37, wherein said specification selected from a specification dictionary comprising a plurality of specifications, each of said plurality of specifications containing additional information relating to each of said plurality of instances, said specification dictionary configurable pursuant to said user's needs.

42. The method of claim 37, wherein said first organizational taxonomy domain and said second organizational taxonomy domain are selected by a user from a hierarchical organization taxonomy, said hierarchical organization taxonomy comprising a plurality of taxonomy domains, each having at least one from the group of a super domain and a sub-domain.

43. The method of claim 37, wherein said first architectural taxonomy domain and said second architectural taxonomy domain are selected by a user from a hierarchical IT architecture taxonomy, said hierarchical IT architecture taxonomy comprising a plurality of taxonomy domains, each having at least one from the group of a super domain and a sub-domain.

44. The method of claim 37, further comprising:
identifying a third Instance related to a third association between a third organization taxonomy domain and a third architecture taxonomy domain; and
determining a change in said third instance as a result of modifying said first instance.

45. A method for facilitating cost control in IT asset management, said method comprising the steps of:
selecting an organization taxonomy domain from a hierarchical organization taxonomy comprising multiple organization taxonomy domains;
selecting an architecture taxonomy domain from a hierarchical architecture taxonomy comprising multiple architecture taxonomy domains;
searching a database based upon an association between said organization taxonomy domain and said architecture taxonomy domain to identify one or more instances related to said association, each of said one or more instances comprising a specific item of cost; and
calculating, for said organization taxonomy domain associated with said architecture taxonomy domain, a total cost of said one or more instances based upon said specific item of cost.

46. The method of claim 45, further comprising:
selecting a first organization taxonomy domain from said hierarchical organization taxonomy;
associating said first organization taxonomy domain with said architecture taxonomy domain;
searching said database to identify a first group of instances related to said first organization taxonomy domain associated with said architecture taxonomy domain; and
calculating for said first organization taxonomy domain associated with said architecture taxonomy domain, a total cost of said second group of instances based upon a specific cost that each of said second group of instances contains.

47. The method of claim 45, further comprising:
selecting a second architecture taxonomy domain from said hierarchical architecture taxonomy;
associating said organization taxonomy domain with said second architecture taxonomy domain;
searching said database to identify a second group of instances related to said organization taxonomy domain associated with said second architecture taxonomy domain; and
calculating for said organization taxonomy domain associated with said second architecture taxonomy domain, a total cost of said second group of instances based upon a specific cost that each of said second group of instances contains.

48. The method of claim 45, further comprising:
calculating, for each one of said multiple organization taxonomy domains of said first hierarchical organization taxonomy, a total cost of having all instances related to said one of said multiple organization taxonomy domains associated with said architecture domain.

49. The method of claim 45, further comprising:
generating a cost report for said organization taxonomy, said cost report listing a set of total costs relating to instances relating to each one of said multiple organization taxonomy domains associated with said architecture domain.

50. The method of claim 45, wherein each of said one or more instances is identified through the steps of:
generating an environment status for said association, said environment status comprising one or more statuses,
generating a lifespan stage for said association, said lifespan stage comprising one or more stages, said one or more stages corresponding to said one or more statues of said environment status,
for each of said one or more statuses of said environmental status, determining whether an instance related to said association exists in said status,
responsive to the determination that said instance exists in said status, selecting, from said one or more stages of said lifespan stage, a stage for said instance based in part upon said status, and
further identifying a stage term and a date of entry for said instance in said stage.
